(19) United States
(12) Patent Application Publication
(10) Pub. No.: US 2024/0350972 A1
(43) Pub. Date: Oct. 24, 2024

(54) Ship Based Carbon Capture, Systems and Methods of Use Thereof

(71) Applicant: Calcarea, Inc., Los Angeles, CA (US)

(72) Inventors: Jess Firey Adkins, Altadena, CA (US); Pierre Forin, Los Angeles, CA (US); Melissa Gutierrez, Los Angeles, CA (US)

(73) Assignee: Calcarea, Inc., Los Angeles, CA (US)

(21) Appl. No.: 18/645,286

(22) Filed: Apr. 24, 2024

Related U.S. Application Data
(60) Provisional application No. 63/497,890, filed on Apr. 24, 2023.

(51) Int. Cl. B01D 53/78; B01D 53/14; B01D 53/18; B01D 53/50; B01D 53/62; B01D 53/75

(52) U.S. Cl. CPC B01D 53/78; B01D 53/1475; B01D 53/1493; B01D 53/18; B01D 53/501; B01D 53/62; B01D 53/75; B01D 2251/404; B01D 2251/606; B01D 2252/1035; B01D 2257/302; B01D 2257/504; B01D 2259/4566

(57) ABSTRACT

Many embodiments are directed to reactors and methods for reducing ship exhaust polluting emissions. Many such embodiments are directed to reactors implementing accelerated weathering of limestone (AWL) for carbon dioxide sequestration. Certain embodiments may also be used to mitigate high acidity of SOₓ scrubber effluents, while some embodiments solve both issues (i.e., seawater acidification and carbon dioxide pollution). Many embodiments are implemented on cargo ships (e.g., container ships and/or bulk carriers) and use seawater. Certain embodiments can utilize effluent from one or more SOₓ scrubbers as the source of seawater to decarbonize and/or neutralize water prior to being safely and permanently stored in the ocean.

### CROSS-REFERENCE TO RELATED APPLICATIONS

The present application claims priority under 35 U.S.C. 119 (e) to U.S. Provisional Application No. 63/497,890 filed Apr. 24, 2023, the disclosure of which is incorporated herein by reference in its entirety.

### FIELD OF THE INVENTION

The current disclosure is directed to methods of carbon dioxide sequestration, more specifically, to ship-based reactors capable of sequestering carbon dioxide and/or deacidifying SOₓ scrubber effluent.

### BACKGROUND OF THE INVENTION

Carbon dioxide (CO₂) constitutes about 0.04% (400 parts per million) of the atmosphere. Despite its relatively small overall concentration, CO₂ is a potent greenhouse gas that plays an important role in regulating the Earth's surface temperature. Presently, anthropogenic CO₂ generation is taking place at a rate greater than it is being consumed and/or stored, leading to increasing concentrations of CO₂ in the atmosphere. As such, there is a growing concern that rising levels of CO₂ in the earth's atmosphere may present a substantial environmental challenge, and an increased interest in developing methods for removing CO₂ from emission streams and the atmosphere, as well as storing the removed CO₂ in a manner that prevents its future release into the atmosphere. This capture and storage process is collectively known as CO₂ sequestration.

The shipping industry is important for worldwide trade and economic health. Ships, such as container ships and bulk carriers, contribute to worldwide carbon and sulfur output. In response, the International Maritime Organization (IMO) has issued a goal to reduce emissions of sulfur oxides (SOₓ) by 7-fold. This goal gives ship operators two options: install SOₓ scrubbers on ships or change to low sulfur fuels. Notably, a typical seawater SOₓ scrubber functions by intaking the flue gas from a ship's exhaust stack and passing it through a mist of aerosolized seawater pumped from, for example, an underway seachest (as described, for example, in Sasaki et al., Practical Design of Marine SOₓ Scrubber for Mega-Container Ships, Mitsubishi Heavy Industries Technical Rev. vol. 56, no. 3, (September 2019), the disclosure of which is hereby incorporated by reference in its entirety). As such, SOₓ from the exhaust gas readily dissolve into the seawater and quickly oxidize to sulfuric acid. In turn, the bicarbonate ions (i.e., the alkalinity) of the seawater are titrated against the protons made from converting SOₓ into sulfuric acid and, as such, the overall SOₓ scrubbing process produces sulfate ions and CO₂. However, not all of the SOₓ scrubbing process protons are absorbed by the seawater alkalinity, and the pH of the scrubber effluent may be as low as pH 2-3. Accordingly, while the SOₓ scrubbers do reduce SOₓ emissions output, they also acidify their wastewater and also contribute to CO₂ emissions. Thus, there exists a great and urgent need for pollution reducing solutions that both reduce the carbon dioxide emissions and alleviate the acidification of water resources.

### SUMMARY OF THE INVENTION

Various embodiments are directed to a reactor for integrating an AWL process with a SOₓ scrubbing process on a ship producing CO₂ and SOₓ emissions, the reactor including:
at least one chamber filled with a reaction medium,
a water inlet in fluid communication with an aqueous effluent outlet of an absorber tower,
a gas inlet in fluid communication with a gas effluent outlet of the absorber tower, an AWL effluent outlet, and
any number of pumps, controls, and safety valves necessary for moving seawater and gas through the reactor at a desired rate.

In various such embodiments, the absorber tower is a SOₓ scrubber.

In still various such embodiments, the at least one chamber is filled with the reaction medium in a fashion selected from the group consisting of: fluidized bed, packed bed, and any combination thereof.

In still yet various embodiments, the reaction medium includes a material or reagent selected from the group consisting of: CaO; a carbonate, including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof.

In yet still various such embodiments, the reaction medium is CaCO₃.

In yet various such embodiments, the reaction medium is a fine grained solid.

In various such embodiments, the reactor comprises a plurality of chambers filled with the reaction medium.

In still various such embodiments, wherein the reactor comprises the plurality of chambers, the plurality of chambers is connected in sequence.

In yet still various such embodiments, the plurality of chambers is connected in parallel.

Still various embodiments are directed to a method for alleviating CO₂ and SOₓ emissions pollution produced by a ship including:
installing an AWL reactor aboard the ship, the AWL reactor including:
   at least one chamber filled with a reaction medium,
   a water inlet in fluid communication with an aqueous effluent outlet of a SOₓ scrubber aboard the ship,
   a gas inlet in fluid communication with a gas effluent outlet of the SOₓ scrubber,
   an AWL effluent outlet, and
   any number of pumps, controls, and safety valves necessary for moving seawater and gas through the AWL reactor at a desired rate;
      flowing seawater from the aqueous effluent outlet and a gas from the gas effluent outlet from the SOₓ scrubber into the AWL reactor;
      to mitigate the acidity of the seawater outflowing from the aqueous effluent outlet, while also safely storing carbon dioxide produced by the ship in the ocean.

In various such embodiments, the at least one chamber is filled with the reaction medium in a fashion selected from the group consisting of: fluidized bed, packed bed, and any combination thereof.

In still various such embodiments, the reaction medium includes a material or reagent selected from the group consisting of: CaO; a carbonate, including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof.

In still yet various embodiments, the reaction medium is CaCO₃.

In yet still various such embodiments, the reaction medium is a fine grained solid.

In yet still various such embodiments, the AWL reactor comprises a plurality of chambers filled with the reaction medium.

In various such embodiments, the plurality of chambers is connected in sequence.

In still various such embodiments, the plurality of chambers is connected in parallel.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIGS. 1A and 1B schematically illustrate examples of basic AWL reactor designs, in accordance with embodiments of the application.

FIGS. 2A and 2B schematically illustrate multi-stage AWL reactor designs, in accordance with embodiments of the application.

FIG. 3 provides illustrative model data plots showing the pH values of the effluent exiting the first and second chambers of the AWL reactor as a function of the seawater and flue gas flow rates, in accordance with embodiments of the application.

FIG. 4 provides illustrative model data showing an advantage of splitting water flow into two streams, in accordance with embodiments of the application.

FIG. 5 provides illustrative model data for the overall performance of the AWL reactors when plumbed to the effluent of SOₓ scrubbers, in accordance with embodiments of the application.

FIG. 6A provides data showing the amount of CO₂ stored as a function of the volume needed onboard ship for various seawater flows that do not pass through a SOₓ scrubber; while FIG. 6B shows the same range of seawater flows, but taking advantage of the non-linear response of CO₂ sequestered to seawater flow rate, in accordance with embodiments of the application.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning to the drawings, schemes, and data, embodiments of reactor systems and methods for capturing carbon dioxide emitted by ships and permanently storing it in the ocean are provided. Many such embodiments are directed to reactors implementing accelerated weathering of limestone (AWL) in order to sequester carbon. Certain embodiments may also be used to mitigate the acidity of the effluent of a ship's SOₓ scrubbers, while some embodiments solve both issues (i.e., water acidification and carbon dioxide pollution). Many embodiments are implemented on cargo ships (e.g., container ships and/or bulk carriers) and use seawater. Certain embodiments can utilize effluent from one or more SOₓ scrubbers as the source of seawater to decarbonize and/or neutralize water prior to being safely disposed of into the ambient water.

A conventional AWL process/reactor uptakes CO₂ gas and reacts it with CaCO₃ (commonly known as limestone) in water (often seawater) according to, most generally, the reaction equation:

$$C {O}_{2} + {H}_{2} O + C a C {O}_{3} ⇒ {Ca}^{2 +} + 2 ( {HCO}_{{3}^{-}} ) ,$$

which results in safe and permanent storage of anthropogenic carbon in the ocean as bicarbonate ions. This is the natural buffering process, sometimes called ‘carbonate compensation’ that regulates earth's CO₂ concentration in the atmosphere. However, this process is constrained by 2 rate limiting steps-CO₂ gas adsorption and limestone solids dissolution. More specifically, since AWL processes typically rely on an oversupply of CO₂ as compared to ambient air (i.e., a partial pressure of CO₂ gas (pCO₂) higher than the ambient levels of CO₂), CO₂ gas adsorption by an AWL reactor's reaction medium (e.g., limestone) is often faster than the dissolution of that reactor's reaction medium's solids, resulting in an incomplete titration of the incoming CO₂.

This application is directed to embodiments of a reactor and a method for integrating an AWL process with a SOₓ scrubbing process on a ship producing CO₂ and SOₓ emissions, such as to mitigate the acidity of the aqueous effluent of the SOₓ scrubbing process, while also safely storing carbon dioxide from the ship's exhaust in the ocean. More specifically, in many embodiments, the aqueous (e.g., seawater-based) effluent of a ship's SOₓ scrubber is fed into an AWL reactor, along with, optionally, the gas effluent of the same SOₓ scrubber (potentially still containing a portion of the ship's exhaust CO₂ that escaped being dissolved in the aqueous effluent), wherein the SOₓ scrubber's aqueous and gas effluents are contacted with an AWL reaction medium, such as, for example, limestone, disposed within a chamber of the AWL reactor. As such, in many embodiments, upon contact with the AWL reaction medium, both the sulfuric acid protons from the SOₓ scrubber's aqueous effluent and CO₂ from the ship's flue gas react with the reaction medium to produce bicarbonate ions (HCO₃⁻) in solution to be released into the ship's surrounding water for safe and permanent storage of CO₂ in the ocean. In some embodiments, the SOₓ scrubber is any absorber tower functioning similarly to a SOₓ scrubber—i.e., intaking exhaust gas from a ship's exhaust and passing it through a mist of aerosolized seawater to absorb the exhaust gases, including CO₂, into the seawater to be fed into the AWL reactor of embodiments.

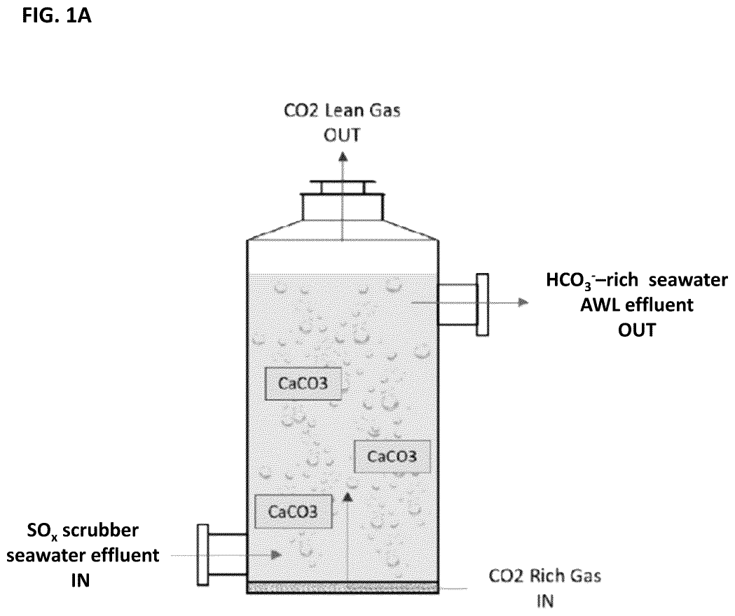

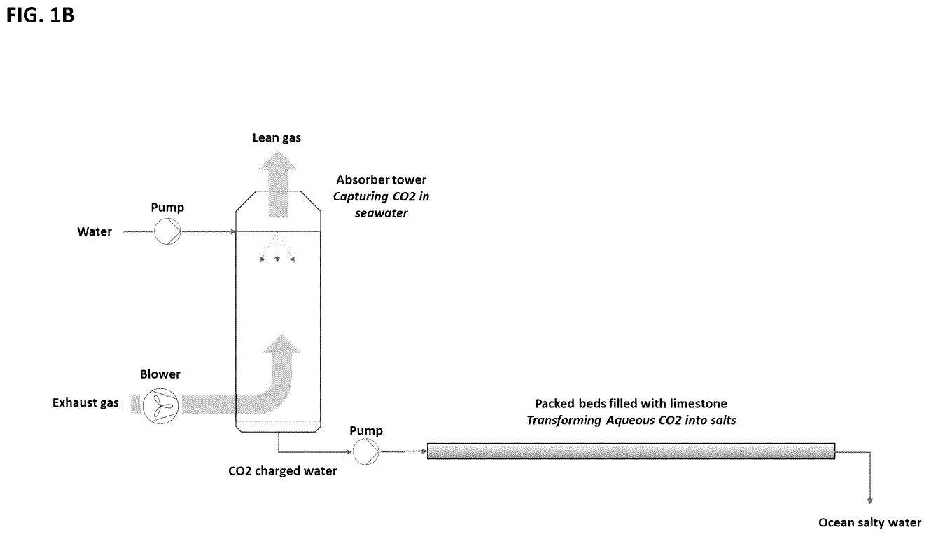

FIGS. 1A and 1B provide examples of the most basic AWL reactors of many embodiments. To this end, in many embodiments, the AWL reactor at least comprises: at least one chamber filled with the AWL reaction medium (e.g., limestone), a water inlet in fluid communication with an aqueous effluent outlet of the SOₓ scrubber (FIG. 1A) or another absorber tower (FIG. 1B), a gas inlet in fluid communication with a gas effluent of the SOₓ scrubber (FIG. 1A), an AWL effluent outlet, and any number of pumps, controls, and safety valves necessary for moving seawater and gas through the reactor at a desired rate. In many embodiments, the at least one chamber is filled with the reaction medium in a fashion selected from the group consisting of: fluidized bed (FIG. 1A), packed bed (FIG. 1B), and any combination thereof. In some embodiments the packed bed chamber is as long as 20 meters or longer, and as thick as 0.15 m or thicker. In many embodiments, the AWL reaction medium comprises a material or reagent selected from the group consisting of: CaO; a carbonate, including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof. In many embodiments, the reaction medium is CaCO₃ (limestone). In many embodiments, the reaction medium is a fine grained solid. Accordingly, in many embodiments, the aqueous/seawater effluent of a ship's SOₓ scrubber or another gas absorbing implement is flown into the AWL reactor, along with some optional amount of the same SOₓ scrubber's gas effluent, wherein the seawater effluent and gas are mixed and contacted with the reaction medium disposed within the at least one of the AWL reactor's chambers, before being released into the ocean as an AWL effluent rich in bicarbonate ions, thus reducing the acidity of the SOₓ scrubber's effluent and safely and permanently storing the ship's emitted CO₂ in the ocean.

In many embodiments, the SOₓ scrubber's aqueous effluent is the only source of the seawater feed into the AWL reactor and, thus, defines the flow rate of water through the AWL reactor according to the pre-existing flow rate of the SOₓ scrubber. In some such embodiments, the SOₓ scrubber′ gas effluent is then used to adjust the flow rate of gas through the AWL reactor as needed to optimize the conditions of the AWL process and the performance of the AWL reactor to capture the most CO₂ at the lowest cost. However, in some embodiments, any additional amount of seawater is pumped into the AWL reactor directly from the ship's ambient water as needed to optimize the AWL process and reactor performance.

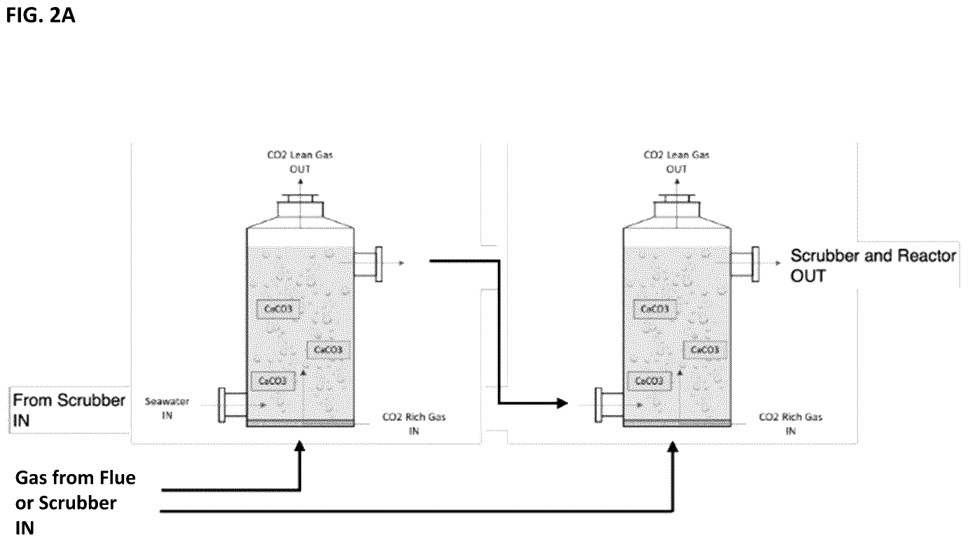

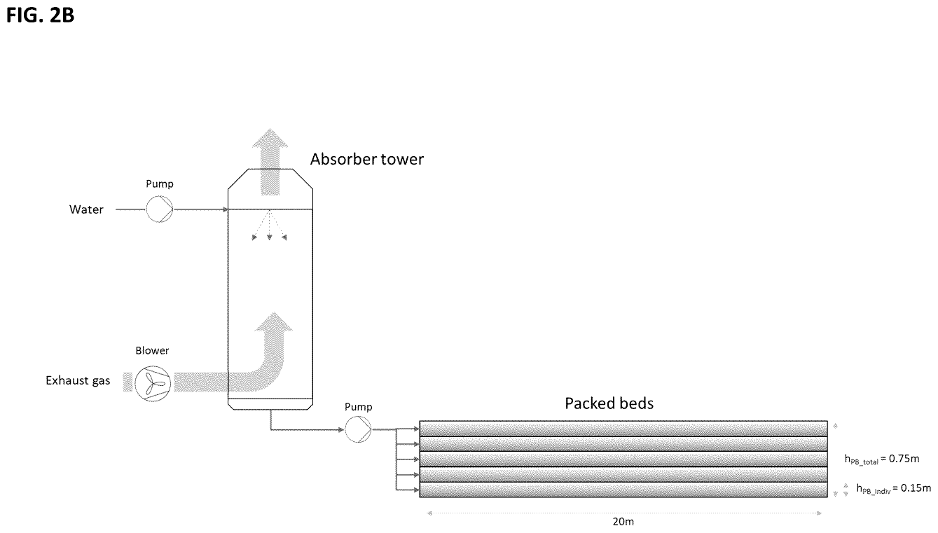

In many embodiments, the AWL process and reactor are multi-stage, incorporating any number of SOₓ scrubbing towers and AWL chambers to achieve the most efficient and effective capture of the ship's exhaust CO₂ within constraints of a ship. For example, FIGS. 2A and 2B show examples of such multi-stage AWL reactors of many embodiments. More specifically, FIG. 2A illustrates the AWL reactor of many embodiments comprising two consecutively connected AWL reactor chambers, wherein the aqueous effluent from the SOₓ scrubber first enters a first AWL chamber, where most of the aqueous effluent's acidity and some CO₂ are removed from the effluent, and is then flown into a second AWL chamber to remove additional carbon dioxide from the effluent. Furthermore, in this particular example, the gas effluent coming off the SOₓ scrubber is split into two parallel streams, where a first portion of the gas effluent is pumped into the first AWL chamber and a second portion of the gas effluent is pumped into the second AWL chamber, in order to facilitate the control over the gas flow rate through the AWL chambers and enable the optimization of the AWL process of many embodiments.

On the other hand, FIG. 2B illustrates an alternative set-up of the AWL reactor of many embodiments, wherein the AWL reactor comprises a plurality of AWL chambers (here, packed beds of the AWL reaction medium) connected in parallel. In some embodiments, the AWL reactor is a stack of at least five such packed bed columns comprising the reaction medium, each 20 meters long and 0.15 meters thick, to the overall reactor dimensions of 20×0.75×0.15 meters. In this particular example, the aqueous effluent from the SOₓ scrubber (here, absorber tower) is split into multiple streams flown through the plurality of AWL chambers. In many embodiments, the set-up illustrated in FIG. 2B allows to compensate for the mismatch between the rates of the CO₂ gas adsorption into the aqueous effluent and limestone solids dissolution, thus, greatly improving the overall efficiency of the AWL process of many embodiments.

In general, in many embodiments, any number of AWL chambers are interconnected in any way (including in sequence or in parallel) with any number of SOₓ scrubbers, SOₓ scrubber-type absorber towers, and ship's exhaust as needed to optimize the water and gas flow rates, such as to achieve the most efficient AWL process and capture most carbon dioxide at the lowest cost. However, it should be noted here, that reversing the flow of the aqueous effluent from the AWL reactor/chambers to the SOₓ scrubber in particular is not advisable, as the SOₓ scrubbing process may acidify the aqueous effluent, thus eliminating any benefit to the buffering ability of the AWL reaction medium (e.g., limestone). In addition, in many embodiments, a variety of pumps, monitors, and safety valves are added for the same purpose. In many embodiments, the AWL reactor is positioned within the ship below the ship's waterline. In many such embodiments, any additional seawater that may be needed for optimization of the onboard AWL processes may be delivered to the AWL reactor by virtue of the ship's movement across water, without any need for additional pumps.

### EXEMPLARY EMBODIMENTS

Although the following embodiments provide details on certain embodiments of the inventions, it should be understood that these are only exemplary in nature, and are not intended to limit the scope of the invention.

### Example 1: Acid Neutralization

Background: Ambient seawater that moves into the SOₓ scrubber is at a pH of 7.8-8.1 in the open ocean. The pH of the aqueous effluent coming out of the SOₓ scrubber, without any dilution by extra seawater, is pH is 2-3. Thus, neutralizing the SOₓ effluent is important to avoid damage to sea life and/or infrastructure.

Methods: To explore the scope of acid neutralization and carbon sequestration by the AWL reactor of many embodiments a series of calculations were performed. In particular, first, the chemistry, especially the pH of the water, before and after the addition of the AWL fluidized bed reactor shown in FIG. 2A to a Panamax sized ship producing 64,000 kg/hr of exhaust with a CO₂ concentration of 5% was documented. Here, the reference SOₓ scrubber had a seawater flow of 700 m³/hr or ˜200 L/sec.

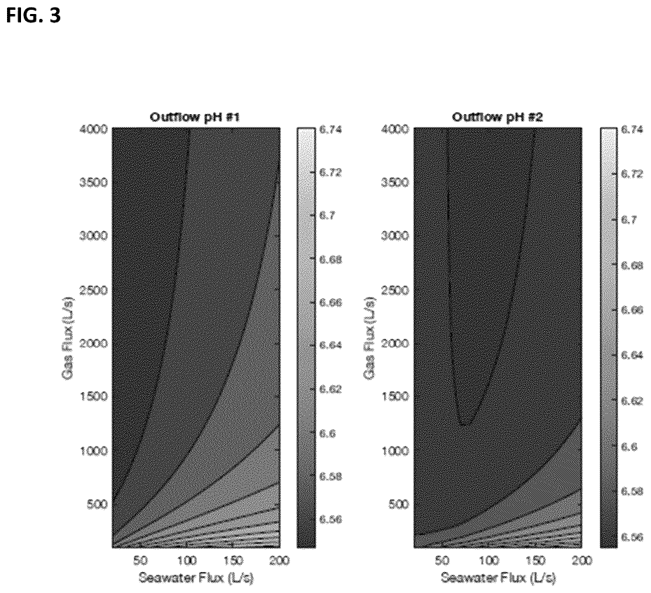

Results: FIG. 3 provides plots showing the pH of the AWL effluent coming out of the first and second AWL chambers of the AWL reactor, respectively, as a function of the aqueous effluent and gas effluent flow rates. Here, the AWL effluent from the first chamber has a pH between 6.56 and 6.74, representing substantial neutralization of the sulfuric acid acidity generated by the SOₓ scrubber. Furthermore, the AWL effluent from the second AWL chamber shows the same pH range with slightly lower values at the same seawater and gas flux rates due to the introduction of fresh CO₂ from the ship's exhaust stack.

Conclusions: This example illustrates the ability of the AWL reactor to neutralize acidified effluent exiting a SOₓ scrubber.

### Example 2: Carbon Capture

Background: The acidity of the SOₓ scrubber's aqueous effluent causes abundant bicarbonate (HCO₃⁻) and carbonate (CO₃²⁻) ions to be converted to carbonic acid (H₂CO₃) and, correspondingly, CO₂, which, in turn, affords high partial pressure of CO₂ (pCO₂) in the SOₓ scrubber's effluent, as compared to the flue gas. As such, the first chamber of the AWL reactor as depicted in FIG. 2A does not receive all the CO₂ leaving the ship's exhaust, as it bubbles out from the SOₓ effluent due to high pCO₂.

Methods: It is possible to calculate the total amount of carbon dioxide captured and stored in the AWL reactor's effluent as a function of the gas and water flow rates.

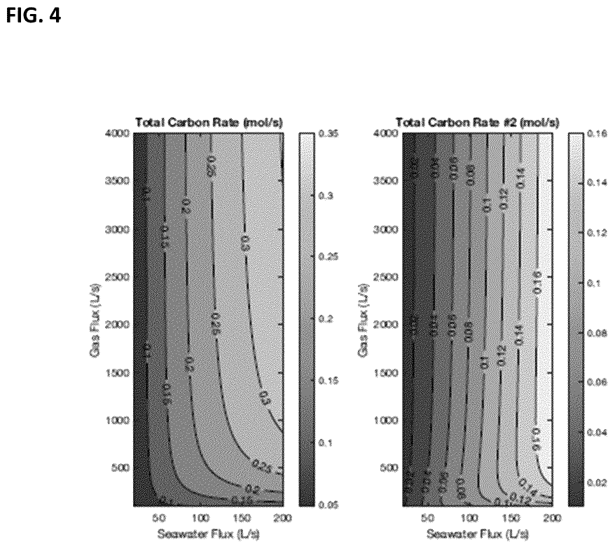

Results: Once the reactor gets to steady-state there has been enough CaCO₃ dissolution to increase the alkalinity and drop the pCO₂ below the flue gas value, but the total carbon stored is less than would be predicted from the alkalinity increase alone. By bubbling in another stream of CO₂-containing flue gas to the aqueous effluent of the first chamber of the AWL reactor water more carbon dioxide is stored in the second chamber, but the amount drops off because now the pCO₂ is large without the water being low in pH. Overall, the calculated rate of carbon capture and sequestration is 0.54 mol/s, which is 2.71% of the 20 mol/s coming through the flue gas. Accordingly, in many embodiments, it is advantageous to split the 200 L/s of water flow into two 100 L/s streams because the lines of constant CCS are closer together at small water flows than they are at larger flow, as illustrated in FIG. 4. This slight non-linearity means 2x 100 L/s streams into two separate pairs of reactors would yield 0.64 mol/s total capture and storage rate, or 3.22% of the total ship's emissions.

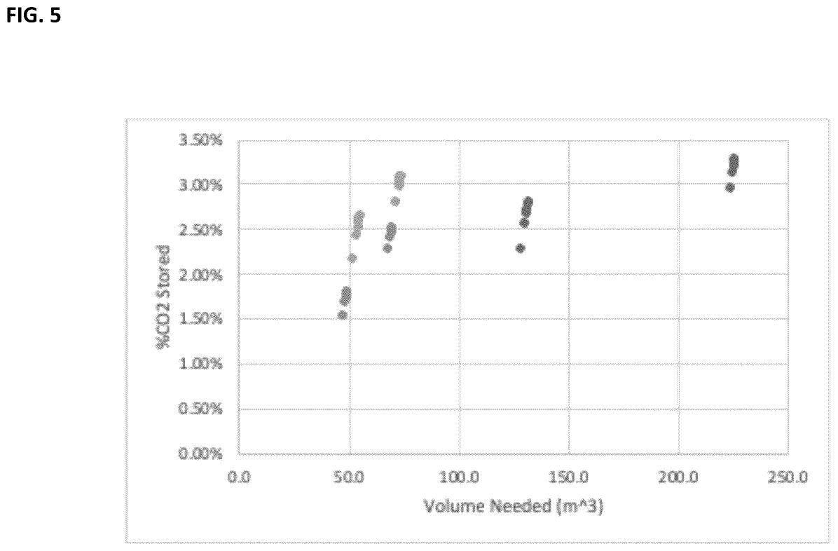

The overall performance of the AWL reactor of many embodiments when plumbed to the effluent of SOₓ scrubbers can be summarized as a function of gas flow and the volume occupied by AWL reactors and the necessary limestone, as illustrated in FIG. 5. The three different shades in this figure represent: Std case with 45 m³ volume reactor and Kla (the gas transfer coefficient)=0.2/sec (blue), 7.5 m³ reactor with Kla=0.2/see (orange), and 7.5 m³ reactor with Kla=0.6/sec (gray). The two sets of trends are for 2×100 L/s (higher CO₂ storage rates but larger volumes) and 1×200 L/s through a single reactor. These different sensitivities arise from the non-linearity of CO₂ sequestration with seawater flow rate. Points along each trend are from varying the gas flow rate from 500-4,000 L/s.

Conclusions: This example illustrates the ability of the AWL reactor to capture carbon dioxide from the SOₓ scrubber's effluent.

### Example 3: Carbon Capture Without Using A SOₓ Scrubber

Background: Certain ships may need carbon sequestration without using SOₓ scrubber's effluent, such as when using low-sulfur fuels and/or if there is no practical means to connect a SOₓ reactor to an AWL reactor. For instance, bulk carriers have 2×1,000 m³/hr pumps on board for use at port during loading and unloading. These pumps move ballast seawater to ensure the ship is stable as heavy loads are added to, or removed from, the ship while at the dock.

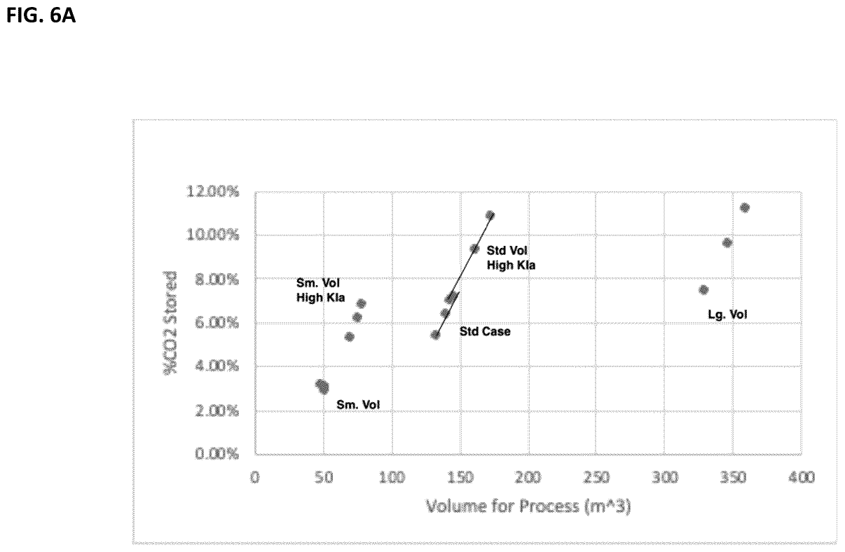

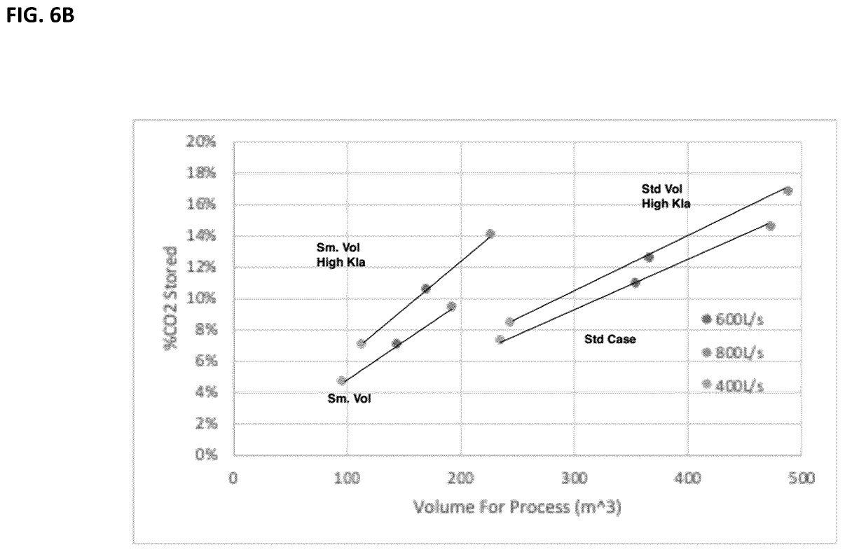

Methods: By using these pumps while the ship is underway, it is possible to calculate the amount of carbon stored as a function of seawater and gas flow rates. For 400, 600, and 800 L/s of seawater flows and 4000 L/s of exhaust gas flow the amount of CO₂ stored as a function of the volume needed onboard ship is shown in FIG. 6.

Results: Each set of three seawater flows form a set of dots along a line where the size of a reactor and the gas exchange coefficient (Kla) are changed in the model. These embodiments can sequester 7% of a Panamax's CO₂ emissions using the 2×1,000 m³/hr ballast pumps and taking ˜140 m³ of space on the ship. As these ships have ˜50,000 m³ of cargo space the AWL reactor equipment could be thought of as non-invasive. In addition, FIG. 7 shows modeling results for the same range of seawater flows as FIG. 6, but now taking advantage of the non-linear response of CO₂ sequestered to seawater flow rate. As such, the AWL reactor of many embodiments can sequester ˜11% of the CO₂ using 350 m³ of space on the vessel.

Conclusions: This example illustrates the ability of the AWL reactor of many embodiments to capture carbon dioxide by using ballast pumps or another source of non-acidified seawater.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A reactor for integrating an AWL process with a SOₓ scrubbing process on a ship producing CO₂ and SOₓ emissions, the reactor comprising:
at least one chamber filled with a reaction medium,
a water inlet in fluid communication with an aqueous effluent outlet of an absorber tower,
a gas inlet in fluid communication with a gas effluent outlet of the absorber tower, an AWL effluent outlet, and
any number of pumps, controls, and safety valves necessary for moving seawater and gas through the reactor at a desired rate.

2. The reactor of claim 1, wherein the absorber tower is a SOₓ scrubber.

3. The reactor of claim 1, wherein the at least one chamber is filled with the reaction medium in a fashion selected from the group consisting of: fluidized bed, packed bed, and any combination thereof.

4. The reactor of claim 1, wherein the reaction medium comprises a material or reagent selected from the group consisting of: CaO; a carbonate, including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof.

5. The reactor of claim 1, wherein, the reaction medium is CaCO₃.

6. The reactor of claim 1, wherein the reaction medium is a fine grained solid.

7. The reactor of claim 1, wherein the reactor comprises a plurality of chambers filled with the reaction medium.

8. The reactor of claim 7, wherein the plurality of chambers is connected in sequence.

9. The reactor of claim 7, wherein the plurality of chambers is connected in parallel.

10. A method for alleviating CO₂ and SOₓ emissions pollution produced by a ship comprising:
installing an AWL reactor aboard the ship, the AWL reactor comprising:
at least one chamber filled with a reaction medium,
a water inlet in fluid communication with an aqueous effluent outlet of a SOₓ scrubber aboard the ship,
a gas inlet in fluid communication with a gas effluent outlet of the SOₓ scrubber,
an AWL effluent outlet, and
any number of pumps, controls, and safety valves necessary for moving seawater and gas through the AWL reactor at a desired rate;
flowing seawater from the aqueous effluent outlet and a gas from the gas effluent outlet from the SOₓ scrubber into the AWL reactor;
to mitigate the acidity of the seawater outflowing from the aqueous effluent outlet, while also safely storing carbon dioxide produced by the ship in the ocean.

11. The method of claim 10, wherein the at least one chamber is filled with the reaction medium in a fashion selected from the group consisting of: fluidized bed, packed bed, and any combination thereof.

12. The method of claim 10, wherein the reaction medium comprises a material or reagent selected from the group consisting of: CaO; a carbonate, including its aragonite, calcite and vaterite forms, dolomite, and Na₂CO₃; NaHCO₃; a silicate, including MgSiO₃, olivine, pyroxene, mafic rock; another material capable of sequestering CO₂, and any combination thereof.

13. The method of claim 10, wherein the reaction medium is CaCO₃.

14. The method of claim 10, wherein the reaction medium is a fine grained solid.

15. The method of claim 10, wherein the AWL reactor comprises a plurality of chambers filled with the reaction medium.

16. The method of claim 15, wherein the plurality of chambers is connected in sequence.

17. The method of claim 15, wherein the plurality of chambers is connected in parallel.
